(19) United States
(12) Patent Application Publication
(10) Pub. No.: US 2024/0020145 A1
(43) Pub. Date: Jan. 18, 2024

(54) UPDATING DEVICE FIRMWARES ON HOSTS IN A DISTRIBUTED CONTAINER ORCHESTRATION SYSTEM

(71) Applicant: VMware, Inc., Palo Alto, CA (US)

(72) Inventors: Yan QI, Beijing (CN); Jian LAN, Beijing (CN); Prachi DALVI, Fremont, CA (US); Liang CUI, Beijing (CN); Todd SABIN, Morganville, NJ (US); Hemanth Kumar PANNEM, Danville, CA (US)

(21) Appl. No.: 17/902,308

(22) Filed: Sep. 2, 2022

(30) Foreign Application Priority Data
Jul. 18, 2022 (WO) PCT/CN2022/106207

(51) Int. Cl. G06F 9/455; G06F 8/65

(52) U.S. Cl. CPC G06F 9/45558; G06F 9/45541; G06F 8/65; G06F 2009/45595

(57) ABSTRACT

An example method of updating device firmware in a distributed container orchestration system includes: receiving, at a master server executing in a data center, a definition for a firmware custom resource; obtaining, by an operator of the master server in response to the firmware custom resource, a firmware file set; providing, from the operator to a plurality of remote sites in communication with the data center, the firmware file set; and executing, by servers at the plurality of remote sites, updates of firmware for devices of the servers.

### CROSS-REFERENCE

This application is based upon and claims the benefit of priority from International Patent Application No. PCT/CN2022/106207, filed on Jul. 18, 2022, the entire contents of which are incorporated herein by reference.

### BACKGROUND

Applications today are deployed onto a combination of virtual machines (VMs), containers, application services, and more. For deploying such applications, a container orchestrator (CO) known as Kubernetes® has gained in popularity among application developers. Kubernetes provides a platform for automating deployment, scaling, and operations of application containers across clusters of hosts. It offers flexibility in application development and offers several useful tools for scaling.

In a Kubernetes system, containers are grouped into logical unit called “pods” that execute on nodes in a cluster (also referred to as “node cluster”). Containers in the same pod share the same resources and network and maintain a degree of isolation from containers in other pods. The pods are distributed across nodes of the cluster. In a typical deployment, a node includes an operating system (OS), such as Linux®, and a container engine executing on top of the OS that supports the containers of the pod. A node can be a physical server or a VM.

In a radio access network (RAN) deployment, such as a 5G RAN deployment, cell site network functions can be realized as Kubernetes pods. Each cell site can be deployed with a single server. Hosts at the cell sites require high-speed network interfaces and hardware accelerators to meet network requirements for the RAN deployment. The devices on the hosts should have up-to-date firmwares to leverage enhancements and/or new features. However, each device vendor may have their own processes for updating device firmware. While some vendors may support firmware updates using a common standard, other vendors' update processes do not comply with such standards. Typically, a user must download firmware update files, extract them to a host, and manually run executables/scripts to perform the firmware update. The user would have to do this on each host where the firmware update is desired. A RAN deployment could have many thousands of hosts and, as such, this manual update process is undesirable.

### SUMMARY

Embodiments include a method of updating device firmware in a distributed container orchestration system, including: receiving, at a master server executing in a data center, a definition for a firmware custom resource; obtaining, by an operator of the master server in response to the firmware custom resource, a firmware file set; providing, from the operator to a plurality of remote sites in communication with the data center, the firmware file set; and executing, by servers at the plurality of remote sites, updates of firmware for devices of the servers.

Further embodiments include a non-transitory computer-readable storage medium comprising instructions that cause a computer system to carry out the above methods, as well as a computer system configured to carry out the above methods.

### BRIEF DESCRIPTION OF THE DRAWINGS

FIG. 1 is a block diagram of a virtualized computing system in which embodiments described herein may be implemented.

FIG. 2 is a block diagram depicting a server of a site in a distributed container orchestration system according to embodiments.

FIG. 3 is a block diagram depicting state of a distributed container orchestration system during device firmware update according to embodiments.

FIG. 4 is a flow diagram depicting a method of updating device firmware at remote sites of a distributed container orchestration system according to embodiments.

### DETAILED DESCRIPTION

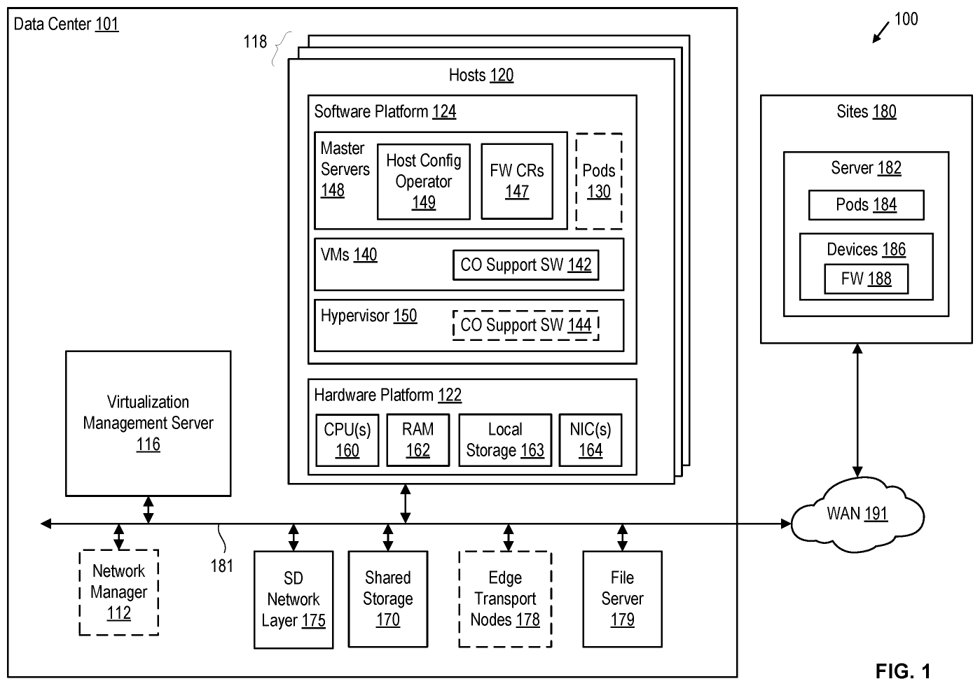

FIG. 1 is a block diagram of a virtualized computing system 100 in which embodiments described herein may be implemented. Virtualized computing system includes a data center 101 in communication with a plurality of sites 180 through a wide area network (WAN) 191 (e.g., the public Internet). Sites 180 can be geographical dispersed with respect to each other and with respect to data center 101. For example, sites 180 can be part of a radio access network (RAN) dispersed across a geographic region and serving different portions of such geographic region. In embodiments, data center 101 comprises a software-defined data center (SDDC) deployed in a cloud, such as a public cloud, private cloud, or multi-cloud system (e.g., a hybrid cloud system). In other embodiments, data center 101 can be deployed by itself outside of any cloud environment.

Data center 101 includes hosts 120. Hosts 120 may be constructed on hardware platforms such as an x86 architecture platforms. One or more groups of hosts 120 can be managed as clusters 118. As shown, a hardware platform 122 of each host 120 includes conventional components of a computing device, such as one or more central processing units (CPUs) 160, system memory (e.g., random access memory (RAM) 162), one or more network interface controllers (NICs) 164, and optionally local storage 163. CPUs 160 are configured to execute instructions, for example, executable instructions that perform one or more operations described herein, which may be stored in RAM 162. NICs 164 enable host 120 to communicate with other devices through a physical network 181. Physical network 181 enables communication between hosts 120 and between other components and hosts 120 (other components discussed further herein).

In the embodiment illustrated in FIG. 1, hosts 120 access shared storage 170 by using NICs 164 to connect to network 181. In another embodiment, each host 120 contains a host bus adapter (HBA) through which input/output operations (IOs) are sent to shared storage 170 over a separate network (e.g., a fibre channel (FC) network). Shared storage 170 include one or more storage arrays, such as a storage area network (SAN), network attached storage (NAS), or the like. Shared storage 170 may comprise magnetic disks, solid-state disks, flash memory, and the like as well as combinations thereof. In some embodiments, hosts 120 include local storage 163 (e.g., hard disk drives, solid-state drives, etc.). Local storage 163 in each host 120 can be aggregated and provisioned as part of a virtual SAN, which is another form of shared storage 170.

A software platform 124 of each host 120 provides a virtualization layer, referred to herein as a hypervisor 150, which directly executes on hardware platform 122. In an embodiment, there is no intervening software, such as a host operating system (OS), between hypervisor 150 and hardware platform 122. Thus, hypervisor 150 is a Type-1 hypervisor (also known as a “bare-metal” hypervisor). As a result, the virtualization layer in host cluster 118 (collectively hypervisors 150) is a bare-metal virtualization layer executing directly on host hardware platforms. Hypervisor 150 abstracts processor, memory, storage, and network resources of hardware platform 122 to provide a virtual machine execution space within which multiple virtual machines (ATM) 140 may be concurrently instantiated and executed. One example of hypervisor 150 that may be configured and used in embodiments described herein is a VMware hypervisor provided as part of the VMware vSphere® solution made commercially available by VMware, Inc. of Palo Alto, CA.

Virtualized computing system 100 is configured with a software-defined (SD) network layer 175. SD network layer 175 includes logical network services executing on virtualized infrastructure of hosts 120. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches and logical routers, as well as logical firewalls, logical virtual private networks (VPNs), logical load balancers, and the like, implemented on top of the virtualized infrastructure. In embodiments, virtualized computing system 100 includes edge transport nodes 178 that provide an interface of host cluster 118 to WAN 191. Edge transport nodes 178 can include a gateway (e.g., implemented by a router) between the internal logical networking of host cluster 118 and the external network. Edge transport nodes 178 can be physical servers or VMs. Virtualized computing system 100 also includes physical network devices (e.g., physical routers/switches) as part of physical network 181, which are not explicitly shown.

Virtualization management server 116 is a physical or virtual server that manages hosts 120 and the hypervisors therein. Virtualization management server 116 installs agent(s) in hypervisor 150 to add a host 120 as a managed entity. Virtualization management server 116 can logically group hosts 120 into host cluster 118 to provide cluster-level functions to hosts 120, such as VM migration between hosts 120 (e.g., for load balancing), distributed power management, dynamic VM placement according to affinity and anti-affinity rules, and high-availability. The number of hosts 120 in host cluster 118 may be one or many. Virtualization management server 116 can manage more than one host cluster 118. While only one virtualization management server 116 is shown, virtualized computing system 100 can include multiple virtualization management servers each managing one or more host clusters.

In an embodiment, virtualized computing system 100 further includes a network manager 112. Network manager 112 is a physical or virtual server that orchestrates SD network layer 175. In an embodiment, network manager 112 comprises one or more virtual servers deployed as VMs. Network manager 112 installs additional agents in hypervisor 150 to add a host 120 as a managed entity, referred to as a transport node. One example of an SD networking platform that can be configured and used in embodiments described herein as network manager 112 and SD network layer 175 is a VMware NSX® platform made commercially available by VMware, Inc. of Palo Alto, CA. In other embodiments, SD network layer 175 is orchestrated and managed by, virtualization management server 116 without the presence of network manager 112.

In embodiments, sites 180 perform software functions using containers. For example, in a RAN, sites 180 can include container network functions (CNFs) deployed as pods 184 by a container orchestrator (CO), such as Kubemetes. The CO control plane includes a master server 148 executing in host(s) 120. A master server 148 can execute in VM(s) 140 and includes various components, such as an application programming interface (API), database, controllers, and the like. A master server 148 is configured to deploy and manage pods 184 executing in sites 180. In some embodiments, a master server 148 can also deploy pods 130 on hosts 120 (e.g., in VMs 140).

In embodiments, VMs 140 include CO support software 142 to support execution of pods 130. CO support software 142 can include, for example, a. container runtime, a CO agent e.g., kubelet), and the like. In some embodiments, hypervisor 150 can include CO support software 144. In embodiments, hypervisor 150 is integrated with a container orchestration control plane, such as a Kubernetes control plane. This integration provides a “supervisor cluster” (i.e., management cluster) that uses VMs to implement both control plane nodes and compute objects managed by the Kubemetes control plane. For example, Kubernetes pods are implemented as “pod VMs,” each of which includes a kernel and container engine that supports execution of containers. The Kubernetes control plane of the supervisor cluster is extended to support VM objects in addition to pods, where the VM objects are implemented using native VMs (as opposed to pod VMs). In such case, CO support software 144 can include a CO agent that cooperates with a master server 148 to deploy pods 130 in pod VMs of VMs 140.

In embodiments, the API of master servers 148 is extended to support firmware (FW) custom resources (CRs) 147. A user can interact with an API server of master server 148 to specify a FW CR 147, which defines a firmware update to firmware 188 of device(s) 186 in server(s) 182 at site(s) 180. Example devices 186 include NICs, hardware accelerators, mainboards, and the like. FW CRs 147 are handled by a host config operator 149 in master servers 148. As described further below, host config operator 149 parses a FW CR 147 to identify the location of a firmware file set for a device firmware update. In embodiments, firmware file sets are stored in a file server 179 in data center 101. Although in other embodiments, file server 179 may be located external to data center 101. Host config operator 149 cooperates with hypervisors in servers 182 to execute a firmware update process, which can update the firmware of one or more devices therein.

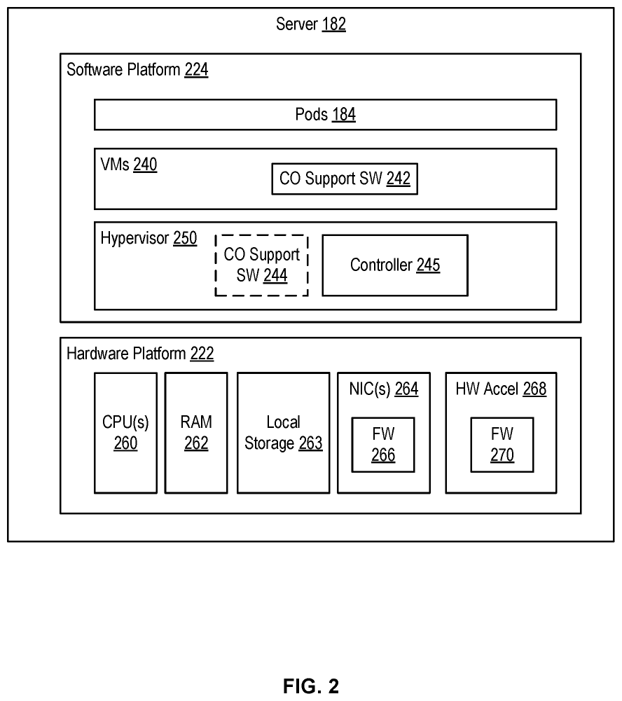

FIG. 2 is a block diagram depicting a server 182 of a site 180 according to embodiments. Server 182 may be constructed on a hardware platform such as an x86 architecture platform. As shown, a hardware platform 222 of server 182 includes conventional components of a computing device, such as one or more CPUs 260, system memory (e.g., RAM 262), one or more NICs 264, hardware accelerators 268, and local storage 263. CPUs 260 are configured to execute instructions, for example, executable instructions that perform one or more operations described herein, which may be stored in RAM 262. NICs 264 enable server 182 to communicate with other devices (i.e., data center 101). Hardware accelerators 268 can perform various processing functions using hardware. In the example, NICs 264 have firmware 266 and hardware accelerators 268 have firmware 270.

A software platform 224 of server 182 includes a hypervisor 250, which directly executes on hardware platform 222. In an embodiment, there is no intervening software, such as a host OS, between hypervisor 250 and hardware platform 222. Thus, hypervisor 250 is a Type-1 hypervisor (also known as a “bare-metal” hypervisor), Hypervisor 150 supports multiple VMs 240, which may be concurrently instantiated and executed. Pods 184 execute in VMs 240. In embodiments, VMs 240 include CO supzzport software 242 to support execution of pods 184. CO support software 242 can include, for example, a container runtime, a CO agent (e.g., kubelet), and the like. In some embodiments, hypervisor 250 can include CO support software 244 that functions as described above with hypervisor 150. Notably, in embodiments, software platform 124 omits a master server, since the CO control plane is located in data center 101. This conserves resources of server 182 for use with pods 184. Hypervisor 250 can include a controller 245 that cooperates with master servers 148. In embodiments, host config operator 149 cooperates with controller 245 to perform firmware updates for devices in hardware platform 222, such as firmware 266 in NICs 264 and firmware 270 in hardware accelerators 268.

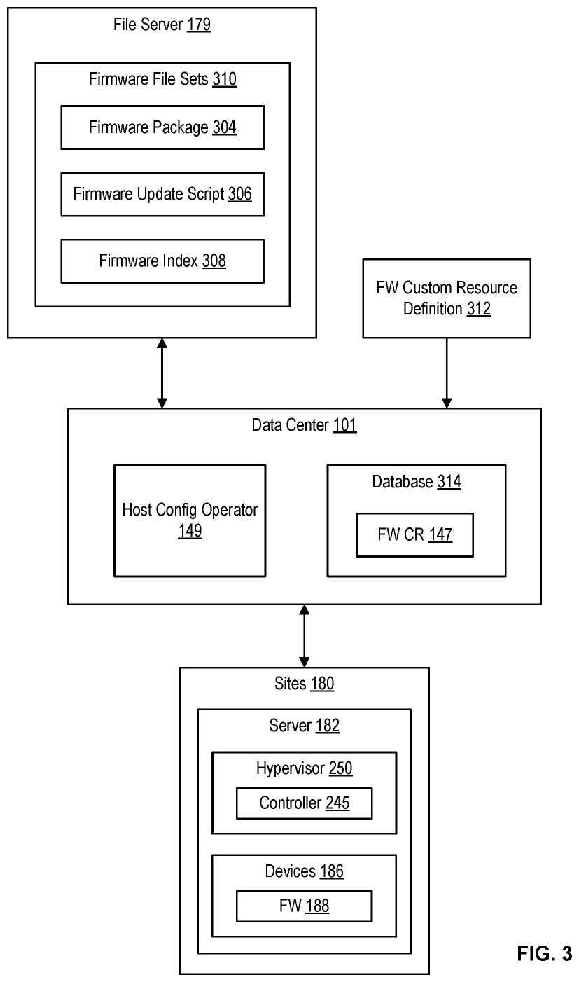

FIG. 3 is a block diagram depicting state of a distributed container orchestration system during device firmware update according to embodiments. As shown, a user interacts with master server 148 to provide a firmware custom resource definition 312. Master server 148 then stores a firmware custom resource 147 in a database 314. Host config operator 149 detects FW CR 147 and performs the device firmware update as specified by the user. In this manner, device firmware is a state of the container orchestration system and such state can be modified by the user using firmware custom resource definitions. Most config operator 149 is configured to perform updates to the firmware state based on FW CRs 147 in database. Firmware custom resource definition 312 is a document that describes state of the firmware update including, for example, a name of the firmware, firm version, a location of a firmware index file, and the like.

File server 179 stores firmware file sets 310. For example, each firmware file set 310 can be in a different directory of a file system organized by device, vendor, firmware name, and the like. In embodiments, each firmware file set 310 includes a firmware package 304, a firmware update script 306, and a firmware index 308. Firmware index 308 can be a text file extensible markup language (XML) file) that describes a firmware package 304 and a firmware update script 306. Firmware index 308 can include checksums of such files that can be used to verify their integrity by host config operator 149. Firmware package 304 includes binary file(s) used to update device firmware. Firmware update script 306 is an executable file that performs a firmware update process. Firmware update script 306 extracts files from firmware package 304 and executes command(s) to perform firmware update. Firmware update script 306 can also include commands for obtaining the current version of device firmware and determining whether a firmware update is needed.

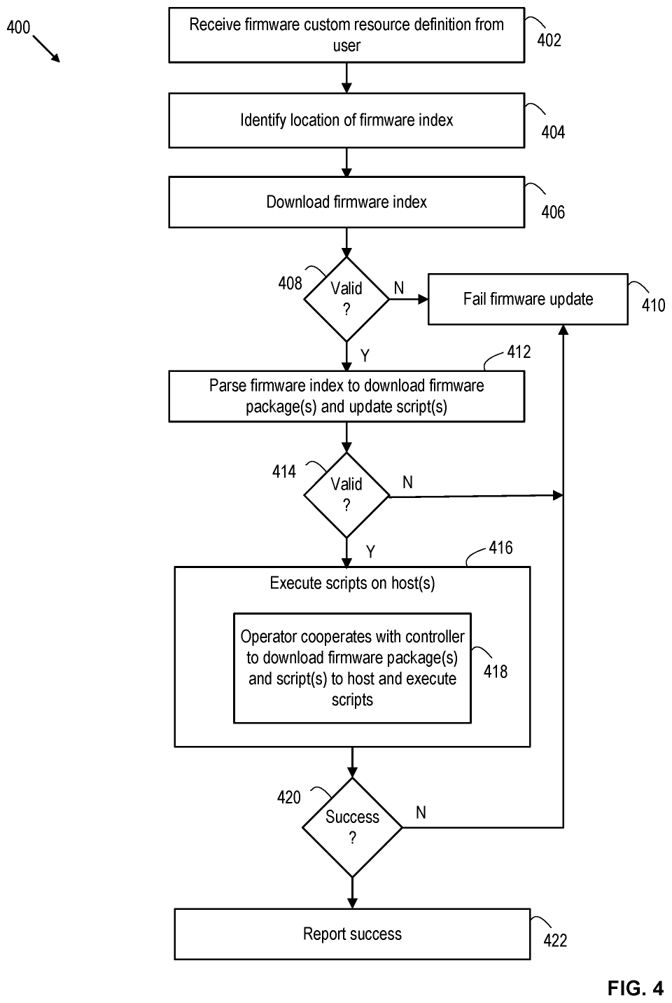

FIG. 4 is a flow diagram depicting a method 400 of updating device firmware at remote sites of a distributed container orchestration system according to embodiments. Method 400 begins at step 402, where master server 148 receives a firmware custom resource definition from a user. At step 404, host config operator 149 identifies a location of a firmware index file from a FW CR 147 generated in response to the user's firmware custom resource definition 312. At step 406, host config operator 149 downloads firmware index 308 from file server 179 as specified in FW CR 147. In embodiments, FW CR 147 can include a checksum for firmware index 308. Thus, at step 408, host config operator 149 determines whether firmware index 308 is valid based on the checksum. If not, method 400 proceeds to step 410, where host config operator 149 fails the firmware update process and notifies the user. If firmware index 308 is valid, method 400 proceeds to step 412.

At step 412, host config operator 149 parses firmware index 308 to download firmware package(s) 304 and firmware update script(s) 306 from file server 179. Host config operator 149 obtains the location of such files from firmware index 308, along with their checksums. At step 414, host config operator 149 determines if firmware package(s) 304 and firmware update scripts) 306 are valid. If not, method 400 proceeds to step 410 and fails the firmware update. Otherwise, method 400 proceeds to step 416.

At step 416 host config operator 149 executes firmware update script(s) 306 on one or more servers 182 at respective one or more sites 180. In embodiments, host config operator 149 can update a plurality of sites concurrently. Host config operator 149 can update site in batches over time to minimize service interruptions. In embodiments, a user can specify an update schedule in firmware custom resource definition 312 (e.g., define the batching process). In embodiments, at step 418, host config operator 149 cooperates with controller 245 in hypervisor 250 to perform the firmware updates. Controller 245 can obtain firmware update script(s) 306 and firmware package(s) 304 from host operator 149. Controller 245 can then execute firmware update scripts) 306 to perform the firmware update(s). Controller 245 can report back to host config operator 149 on the success or failure of firmware update(s). Controller 245 can then restart server 182 if necessary after firmware update(s).

If at step 420 the firmware update(s) are successful, method 400 proceeds to step 422, where host config operator 149 reports success. Otherwise, method 400 proceeds to step 410, where host config operator 149 fails the firmware update for the specified host(s). Note that at step 420 some firmware updates can be successful while other firmware updates can fail.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of updating device firmware in a distributed container orchestration system, comprising:
receiving, at a master server executing in a data center, a firmware custom resource;
obtaining, by an operator of the master server in response to the firmware custom resource, a firmware file set;
providing, from the operator to a plurality of remote sites in communication with the data center, the firmware file set; and
executing, by servers at the plurality of remote sites, updates of firmware for devices of the servers.

2. The method of claim 1, wherein the step of obtaining comprises:
downloading, as indicated in the firmware custom resource, a firmware index from a file server;
downloading, as indicated by the firmware index, a firmware package and a firmware update script from the file server.

3. The method of claim 2, further comprising verifying checksums of the firmware index, firmware package, and the firmware update script by the operator.

4. The method of claim 1, wherein the operator provides the firmware file set to a first remote site of the plurality of remote sites in cooperation with a controller executing in a hypervisor of a server at the first remote site.

5. The method of claim 4, wherein the step of executing comprises:
invoking, by the controller, a firmware update script of the firmware file set, the firmware update script using a firmware package of the firmware file set to update firmware of a device in the server.

6. The method of claim 5, wherein the firmware update script extracts the firmware package.

7. The method of claim 1, wherein the servers at the plurality of remote sites execute pods deployed by the master server, the pods having container network functions (CNFs) of a radio access network (RAN).

8. A non-transitory computer readable medium comprising instructions to be executed in a computing device to cause the computing device to carry out a method of updating device firmware in a distributed container orchestration system, comprising:
receiving, at a master server executing in a data center, a firmware custom resource;
obtaining, by an operator of the master server in response to the firmware custom resource, a firmware file set;
providing, from the operator to a plurality of remote sites in communication with the data center, the firmware file set; and
executing, by servers at the plurality of remote sites, updates of firmware for devices of the servers.

9. The non-transitory computer readable medium of claim 8, wherein the step of obtaining comprises:
downloading, as indicated in the firmware custom resource, a firmware index from a file server;
downloading, as indicated by the firmware index, a firmware package and a firmware update script from the file server.

10. The non-transitory computer readable medium of claim 9, further comprising verifying checksums of the firmware index, firmware package, and the firmware update script by the operator.

11. The non-transitory computer readable medium of claim 8, wherein the operator provides the firmware file set to a first remote site of the plurality of remote sites in cooperation with a controller executing in a hypervisor of a server at the first remote site.

12. The non-transitory computer readable medium of claim 11, wherein the step of executing comprises:
invoking, by the controller, a firmware update script of the firmware file set, the firmware update script using a firmware package of the firmware file set to update firmware of a device in the server.

13. The non-transitory computer readable medium of claim 12, wherein the firmware update script extracts the firmware package.

14. The non-transitory computer readable medium of claim 8, wherein the servers at the plurality of remote sites execute pods deployed by the master server, the pods having container network functions (CNFs) of a radio access network (RAN).

15. A virtualized computing system, comprising:
a data center in communication with remote sites over a network forming a distributed container orchestration system; and
a master server of the distributed container orchestration system executing in the data center, the master server configured to:
receive a firmware custom resource;
obtain, by an operator in response to the firmware custom resource, a firmware file set;
provide, from the operator to the remote sites, the firmware file set; and
cooperate with servers at the plurality of remote sites to execute updates of firmware for devices of the servers.

16. The virtualized computing system of claim 15, wherein the master server is configured to:
download, as indicated in the firmware custom resource, a firmware index from a file server;
download, as indicated by the firmware index, a firmware package and a firmware update script from the file server.

17. The virtualized computing system of claim 16, wherein the master server is configured to verify, by the operator, checksums of the firmware index, firmware package, and the firmware update script.

18. The virtualized computing system of claim 15, wherein the operator provides the firmware file set to a first remote site of the remote sites in cooperation with a controller executing in a hypervisor of a server at the first remote site.

19. The virtualized computing system of claim 18, wherein the server is configured to:
invoke, by the controller, a firmware update script of the firmware file set, the firmware update script using a firmware package of the firmware file set to update firmware of a device in the server.

20. The virtualized computing system of claim 19, wherein the firmware update script extracts the firmware package.
